(19) United States
(12) Patent Application Publication
(10) Pub. No.: US 2008/0130965 A1
(43) Pub. Date: Jun. 5, 2008

(54) Method and apparatus for parameter assisted image-guided surgery (PAIGS)

(76) Inventors: Gopal B. Avinash, New Berlin, WI (US); Allison L. Weiner, Milwaukee, WI (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 10/996,937

(22) Filed: Nov. 23, 2004

(51) Int. Cl. G06K 9/00

(52) U.S. Cl. 382/128

(57) ABSTRACT

Embodiments of methods, apparatuses, devices, and/or systems for performing Parameter Assisted, Image-Guided Surgery (PAIGS) are described. In one particular embodiment, a method of performing PAIGS comprises accessing image data for a surgical object, receiving one or more instrument parameters for a surgical instrument from one or more sensors coupled to the instrument, receiving one or more in situ parameters for the surgical object from one or more sensors coupled to the instrument, providing one or more instrument parameters, in situ parameters, and/or at least a portion of the image data to a registration device, and displaying an image of at least a portion of the instrument parameters, in situ parameters and/or image data on a display device.

### BACKGROUND

Image guided surgery may provide surgeons with access to particular information during a surgical procedure, which may enable less invasive procedures, for example. In at least one type of image guided surgery, images of a patient may be obtained either prior to surgery or intra-operatively. During the procedure, the position and/or orientation of one or more surgical instruments may be tracked. The images of the patient and the tracked instrument data may be merged and presented to a surgeon intra-operatively to guide a surgical procedure.

However, information other than instrument location may be desirable. For example, information regarding tissue characteristics when removing a tumor would be advantageous, proving confirmation to a surgeon that excision is complete. As another example, in the case of neurosurgery, mapping of the brain may be important, since differences of millimeters may result in the difference between loss or gain of brain function or body control, for example. Therefore, a need exists for enhancing image guided surgery, such as by providing data in addition to patient images and/or instrument location.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a block diagram of one embodiment of a parameter assisted image-guided surgery system;

FIG. 2 is a block diagram of one embodiment of a parameter assisted image-guided surgery system;

FIG. 3 is a surgical instrument capable of being utilized in at least one embodiment of parameter assisted image-guided surgery;

FIG. 4 is an image capable of being utilized in at least one embodiment of parameter assisted image-guided surgery;

FIG. 5 is a flowchart illustrating one embodiment of parameter assisted image-guided surgery; and

FIG. 6 is a block diagram of one embodiment of a parameter assisted image-guided surgery system.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail so as not to obscure claimed subject matter.

Surgical procedures may be performed on a surgical object, and a surgical object may comprise a patient or a portion thereof, for example. Surgical procedures such as these may be performed by use of one or more surgical instruments. Precision placement and/or movement of the one or more surgical instruments may be important, particularly if the surgical object is difficult to see or located internally to a patient, for example. Image-guided surgery is a surgical procedure wherein one or more images may be provided to a surgeon, and the one or more images may represent one or more parameters, such as parameters obtained from a patient and/or from a surgical instrument, for example. Images such as these may provide a surgeon with the capability to view parameters of a surgical object and/or one or more other portions of a patient and/or instrument parameters that may otherwise not be available, such as if a surgical object is difficult to see and/or located internally to a patient, for example. However, current state of the art image guided surgery devices and techniques may not provide sufficient information, and/or may provide information in a less than optimal manner, for example. As alluded to previously, parameters, such as instrument and/or patient parameters, may be obtained before and/or during a surgical procedure, and may be obtained in a number of ways. In at least one type of image-guided surgery, an image of a patient, such as an image of a surgical object or one or more other portions of the patient may be obtained prior to the surgical procedure. This image may be provided to a surgeon during a surgical procedure, such as by use of a display device, for example. However, this image may not provide a sufficient amount of information, and/or may present the information in a less than optimal manner, for example. Additionally, it is worthwhile to note that in this context, a surgeon may refer to a human surgeon, but may additionally refer to a robotic surgeon, such as a device capable of performing surgical procedures automatically, and/or a device that may be at least partially controlled by a human surgeon, for example.

One particular type of image-guided surgery comprises parameter assisted image-guided surgery (PAIGS). This particular type of image-guided surgery may utilize multiple sets of data, referred to generally as parameters or parametric data. Numerous differing types and/or categories of parameters may be utilized, and may generally comprise data regarding a patient, such as in situ data of a surgical object and/or a patient, and/or may comprise surgical instrument data, such as orientation, position and/or tracking data, for example. Instrument parameters may include orientation and/or position data of an instrument, and/or may comprise historical orientation and/or position data, which may also be referred to as tracking data, and may be determined based on one or more coordinate systems. For example, instrument data may include, relative x, y, and/or z position of the instrument, and/or pitch, yaw and/or roll of the instrument, as just a few examples. Additionally, in situ parameters may include one or more physical, chemical and/or electrical parameters of a surgical object and/or other portions of a patient, such as pressure, stress, temperature, density, displacement, velocity, flow, acceleration, elasticity, hardness, frequency, oxygen concentration, glucose concentration, spectral information, impedance, potential, and/or current, and/or may comprise one or more parameters at least partially derived therefrom, such as change per unit time of one or more of the parameters, as just a few examples, although it is worthwhile to note that claimed subject matter is not so limited, and the instrument parameters and/or in situ parameters may include one or more additional types of data not described in detail. In at least one embodiment of PAIGS, one or more of the aforementioned instrument and/or in situ parameters may be registered, which may comprise an at least partial integration of the one or more parameters, such that at least a portion of the one or more parameters may be provided to a surgeon, such as by use of a display device, and may be displayed as a substantially integrated image comprising multiple parameters, such as multiple sets of parameters displayed on a single coordinate system, as just an example. However, claimed subject matter is not limited to use of the aforementioned parameters and/or methods of providing the parameters to a surgeon, as will be explained in more detail later.

Although numerous differing types and/or categories of surgical procedures exist, and claimed subject matter is not limited to any particular type and/or category of surgical procedure, at a high level, one or more types of surgical procedures may comprise one or more of the following surgical actions: excising, ablation, cutting, aspirating, implanting and/or analyzing at least a portion of a surgical object. However, the particular surgical procedure may depend at least in part on the particular patient, surgical object or portion thereof, for example. Additionally, a surgical procedure may comprise a plurality of surgical actions, such a combination of one or more of the surgical actions referred to previously. However, particular surgical actions and procedures, as well as surgical objects, may be better understood in reference to the accompanying figures.

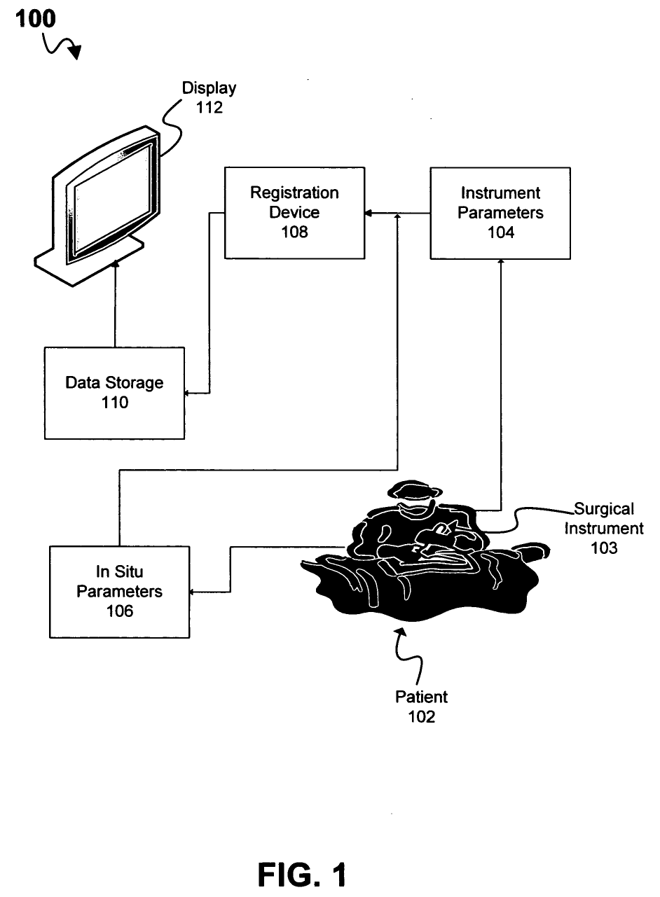

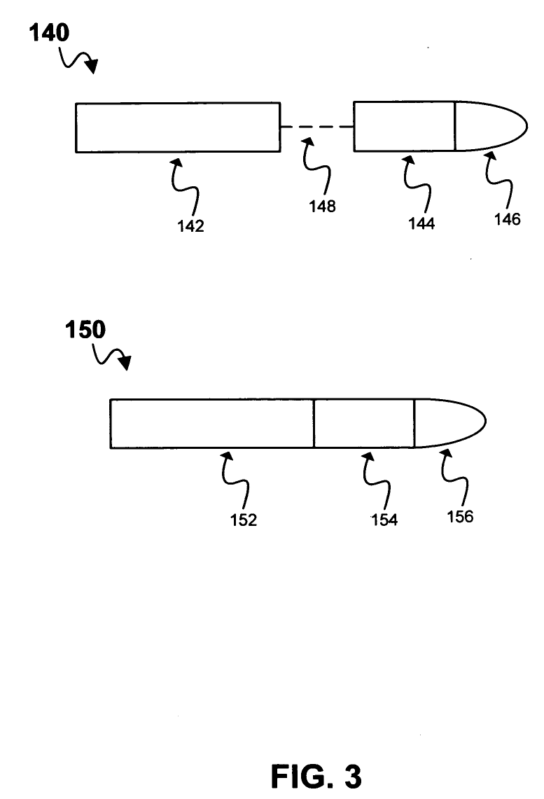

Referring now to FIG. 1, there is illustrated a block diagram of an embodiment of a PAIGS system 100. Illustrated in FIG. 1 is a patient 102, and, although not illustrated in detail, patient 102 may include a surgical object. Additionally, illustrated in FIG. 1 is a surgical instrument 103. Surgical instrument 103 may comprise one or more types of surgical instrument, and the particular instrument may depend, for example, on the particular surgical procedure being performed. However, in at least one embodiment, surgical instrument 103 may comprise an anatomical device, a probe, a drill, a guide, a catheter, a stimulator, a debrider, an aspirator, a curette, forceps, a bovie, a microscope, an endoscope, and/or one or more implants, as just a few examples. Surgical instrument 103 may include one or more sensors (not shown), that may be integrated and/or adjunct to the instrument. The one or more sensors may be capable of providing in situ parameters 106 to registration device 108. In situ parameters 106 may be obtained by use of the one or more sensors of surgical device 103, for example, and may include patient in situ parameters, such as one or more physical, chemical and/or electrical parameters of a surgical object and/or other portions of a patient, as described previously. Additionally, instrument parameters 104 may be provided to registration device 108, and may be obtained by use of the one or more sensors of surgical instrument 103. Instrument parameters may include, for example, position and/or orientation parameters: which may relate to the position and/or orientation of the surgical instrument 103. However, particular details regarding surgical instruments, including sensors, for example, which may be utilized in at least one embodiment, may be better understood with reference to FIG. 3, explained in more detail later.

System 100 may further comprise a registration device 108, data storage device 110, and a display 112. In operation, in situ parameters 106 and/or instrument parameters 104 obtained by one or more sensors coupled to the surgical instrument 103 may be provided to registration device 108. Registration device 108 may be configured to integrate at least a portion of the provided parameters, and may provide at least a portion of the parameters to data storage device 110, for example. Data storage device 110 may be configured to provide at least a portion of the integrated parameters to the display device 112. The display device may display at least a portion of the integrated parameters as one or more images, such as one or more images of a surgical object, and/or one or more images of another portion of the patent, such as by displaying at least a portion of a brain image of a patient during a surgical procedure involving spinal surgery, as just an example. In at least one embodiment, the registration device may comprise a computing system, and may be capable of at least partially integrating parameters such as in situ parameters 106 and/or instrument parameters 104, such as by integrating at least a portion of obtained in situ parameters and instrument parameters in to a substantially unitary set of data that may be capable of being displayed on display 112, such as by displaying multiple sets of parameters on a single coordinate system. For example, registration device 108 may receive two or more sets of parameters, such as in situ and/or instrument parameters. Registration system 108 may then map at least a portion of the parameters on to one or more images stored in data storage 110, such as one or more images of one or more portions of patient 102, for example, that may have been obtained before and/or during the surgical procedure, for example. The mapped parameters and one or more images may then be displayed on display 112, and may provide a surgeon with data that may be utilized during the surgical procedure, for example. Although claimed subject matter is not so limited, in at least one embodiment, display device 112 may comprise a liquid crystal display (LCD), a cathode ray tube (CRT) display, a 3D display, a holographic display and/or a virtual reality display, for example, and, in at least one embodiment, one or more properties of the display device, including brightness and/or contrast, may be at least partially adjustable.

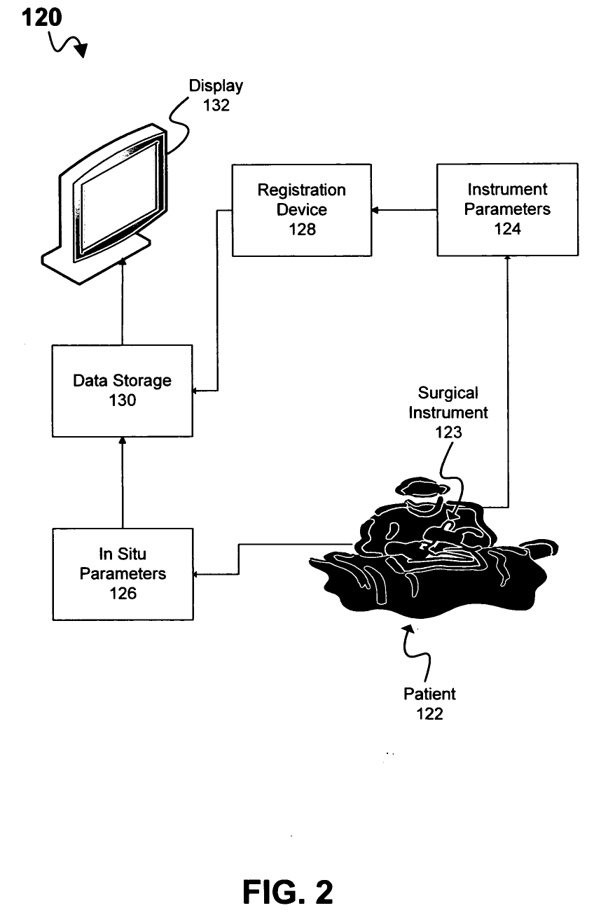

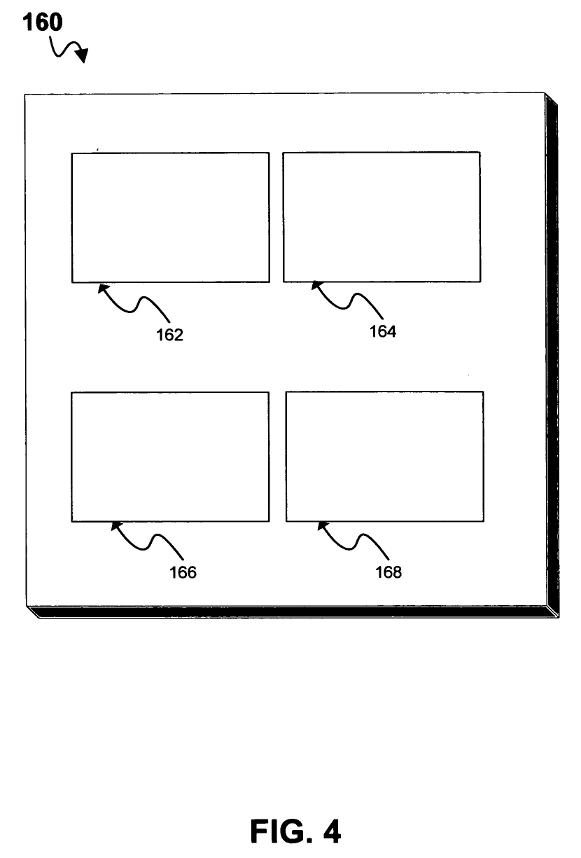

Referring now to FIG. 2, there is illustrated a block diagram of another embodiment of a PAIGS system 120. Similarly to FIG. 1, system 120 comprises a patient 122, a surgical instrument 123, which may include one or more sensors (not shown), a registration device 128, a data storage device 130, and a display 132. In operation, one or more sensors of surgical instrument 123 may be capable of providing instrument parameters 124 to registration device 128. Additionally, one or more sensors of surgical instrument 123 may be capable of providing in situ parameters 126 to data storage device 130. Registration device 128 may comprise a computing system, for example, and may be configured to integrate at least a portion of the provided instrument parameters, such as by mapping at least a portion of the instrument parameters on to one or more images stored in data storage 130, such as one or more images of one or more portions of patient 122 that may have been obtained before and/or during the surgical procedure, for example. Additionally, the provided in situ parameters 126 may be mapped on to one or more images stored in data storage device 130, and/or may be utilized to produce a single image comprising in situ parameters, for example. At least a portion of the provided parameters 124 and 126 may be displayed on display 132, such as by displaying multiple images representing the multiple parameters on an LCD display, for example. However, images, and displaying of images, such as described in FIGS. 1 and 2 may be better understood with reference to FIG. 4, later.

Referring now to FIG. 3, there are illustrated two particular surgical instruments 140 and 150 that may be utilized in one or more embodiments of claimed subject matter. Instruments 140 and 150 are illustrated generally as having multiple portions 142, 144, 146, and 152, 154, 156, respectively, but it is worthwhile to note that claimed subject matter is not so limited, and particular configuration of surgical instruments 140 and/or 150 may depend on the particular embodiments of the instruments. For example, as stated previously, instruments 140 and 150 may comprise, for example, anatomical devices, probes, drills, guides, catheters, stimulators, debriders, aspirators, curettes, forceps, bovie, microscopes, endoscopes, and/or one or more implants, for example. Instruments 140 and 150 may have one or more sensors, and the sensors may be integrated with and/or adjunct to the instrument. For example, instrument 140 may have multiple portions 142, 144 and 146, and portion 142 may be physically separate from portions 144 and 146, for example. Portion 146 may include one or more sensors, such as one or more sensors capable of sensing in situ parameters, for example. Conversely, portion 142 and/or 144 may include one or more sensors capable of sensing instrument data, such as position and/or orientation data, and the one or more sensors, if integrated in portion 142, may be adjunct with respect to portions 144 and 146, for example. In one embodiment, position and/or orientation data may be obtained by use of radio waves, magnetic resonance and/or ultrasonic waves, for example, and may be obtained by a sensor coupled to portion 142, that may be capable of measuring one or more signals provided by one or more of the portions 144 and 146, for example. Additionally, sensor data may be provided to a sensor coupled to portion 142 by use of data transport media 148. Data transport media 148 may depend, of course, on the particular type of sensor(s) coupled to portions 142 and 144, for example. In at least one embodiment, data transport media 148 may comprise optical signals, acoustical signals, and/or wireless signals, as just a few examples. Additionally, one or more cameras and one or more markers may be employed to track portions 144 and/or 146 relative to portion 142, such as by utilizing one or more cameras capable of tracking one or more markers, such as LED markers, to triangulate the position of portions 144 and/or 146, for example. Similarly, instrument 150 may comprise physically integrated portions 152, 154 and 156. One or more of the portions may include one or more integrated sensors capable of sensing instrument and/or in situ data, including one or more of the surgical object parameters and/or position and/or orientation parameters described previously.

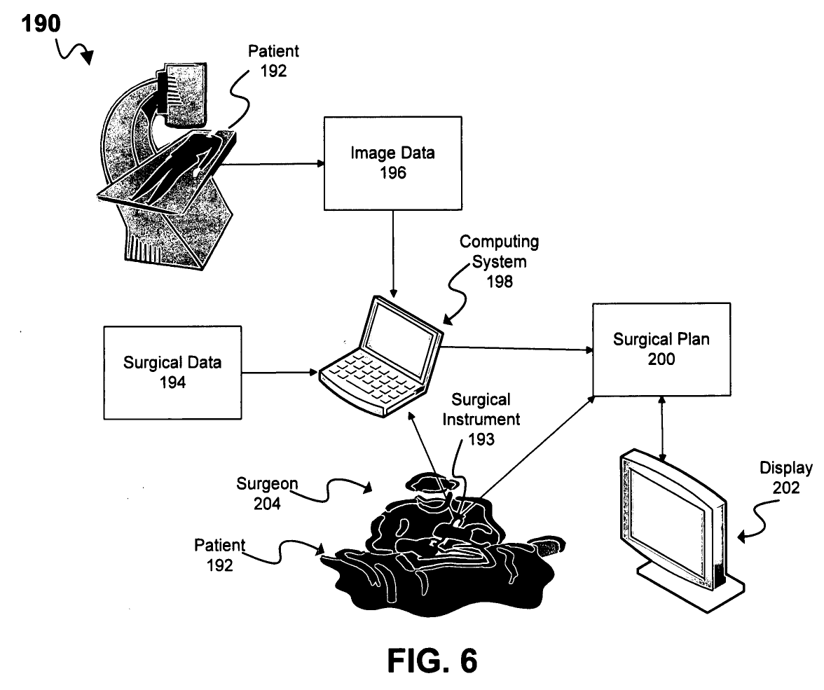

Referring now to FIG. 4, there is illustrated a display device 160, with multiple images 162, 164, 166 and 168 being displayed. As mentioned previously, display device 160 may comprise one or more types of display device, including a liquid crystal display (LCD), a cathode ray tube (CRT) display, a 3D display, a holographic display, and/or virtual reality display, for example. One or more characteristics of the display device 160, such as brightness and/or contrast, may be adjustable, for example. Additionally, although illustrated as having four images, claimed subject matter is not so limited, and display device 160 may be capable of displaying a greater and/or a lesser number of images, for example. Display device 160 may be utilized in one or more PAIGS systems, such as system 100 of FIG. 1, and/or system 120 of FIG. 2, for example. In one embodiment, display device 160 may be utilized in a system such as system 100 of FIG. 1. In this embodiment, in operation, display 160 may display a single image comprising multiple sets of parameters, registered to be displayed on a single image of a surgical object, such as by being displayed on a single coordinate system, for example. The surgical object image may be obtained before and/or during a surgical procedure, and the parameters may comprise instrument parameters and/or surgical object in situ data, for example. Alternatively, display device 160 may be utilized in a system such as system 120 of FIG. 2. In this embodiment, in operation, display 160 may display multiple images, such as images 162, 164, 166 and 168, for example, and the images may comprise particular sets of parameters integrated on to images of a surgical object, such as one or more sets of in situ and instrument data displayed on to surgical object images, as just an example, and/or may comprise one or more images of one or more portions of a patient, such as a brain image of a patient and a spinal image of a patient, which may be displayed during a spinal surgery procedure, for example. Additionally, one or more of the images of display device 160 may comprise a surgical plan, explained in more detail with reference to FIG. 6, below.

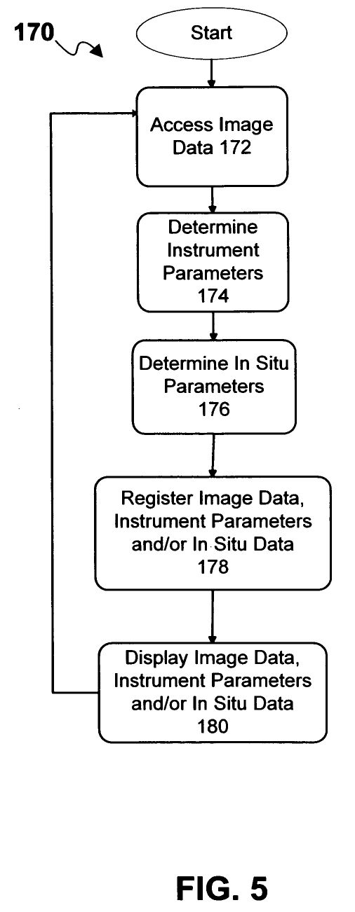

Referring now to FIG. 5, one embodiment of PAIGS is illustrated by a flowchart, although, of course, claimed subject matter is not limited in scope in this respect. Such an embodiment may be employed to at least partially perform PAIGS, as described below. The flowchart illustrated in FIG. 5 may be used in conjunction with a system suitable for performing PAIGS, including system 100 of FIG. 1 and/or system 120 of FIG. 2, for example, although claimed subject matter is not limited in this respect. Likewise, the order in which the blocks are presented does not necessarily limit claimed subject matter to any particular order. Additionally, intervening blocks not shown may be employed without departing from the scope of claimed subject matter.

Flowchart 170 depicted in FIG. 5 may, in alternative embodiments, be implemented in hardware, and/or hardware in combination with software and/or firmware, such as part of a computer system, for example, and may comprise discrete and/or continual operations. In this embodiment, at block 172, image data may be accessed, and may include image data of a surgical object and/or other portions of a patient, for example. At block 174, one or more instrument parameters, such as position and/or orientation data, may be determined. At block 176, one or more in situ parameters, such as one or more physical, chemical and/or electrical parameters, may be determined. At least a portion of the image data, instrument parameters and/or in situ data may be registered at block 178. At block 180, at least a portion of the registered image data, instrument parameters and/or in situ data may be displayed, such as on a display device, for example, and may be displayed as a single integrated image or multiple images, for example. Additionally, one or more blocks may be repeated, such as to access and/or determine additional data, so that an image may be updated with additional data, for example.

In this embodiment, at block 172, image data may be accessed. Image data may comprise one or more images of a surgical object, of one or more other portions of a patient, and/or one or more images of a surgical procedure, such as a surgical procedure performed on another surgical object that may have been recorded, for example. The image data may be stored in a data storage device, which may comprise a database, such as a database stored on a computing system, for example. The one or more images may have been obtained prior to the procedure, and/or may be obtained during the procedure, for example. In this embodiment, at block 174, one or more instrument parameters may be determined. Instrument parameters may include position and/or orientation data of a surgical instrument, and may include historical position and/or orientation data, for example. The particular data may comprise x, y and z coordinate data, and/or yaw, pitch and/or roll of a surgical instrument, such as relative to a surgical object, for example. The instrument parameters may be obtained by one or more sensors, such as integrated and/or adjunct sensors of a surgical instrument, such as illustrated in FIG. 3, for example.

In this embodiment, at block 176, one or more in situ parameters may be determined. The in situ parameters may include in situ parameters such as one or more physical, chemical and/or electrical parameters of a patient and/or surgical object, such as pressure, stress, temperature, density, displacement, velocity, flow, acceleration, elasticity, hardness, frequency, oxygen concentration, glucose concentration, spectral information, impedance, potential, and/or current, and/or may comprise one or more parameters at least partially derived therefrom, such as change per unit time of one or more of the parameters, as stated previously. The in situ parameters may be obtained by use of one or more sensors, which may be integrated and/or adjunct with respect to a surgical instrument, such as illustrated in FIG. 3, for example. In this embodiment, at block 178, one or more of the determined in situ parameters and instrument parameters and/or image data may be registered. This may comprise utilizing a computing system to at least partially integrate the parameters obtained by a surgical instrument and/or image data in to a substantially unitary set of data that may be capable of being displayed on a display device, such as a liquid crystal display (LCD), a cathode ray tube (CRT) display, a 3D display, a holographic display and/or a virtual reality display, for example. For example, two or more sets of parameters, such as in situ and/or instrument parameters, as well as image data, may be provided to a registration system. The registration system may then map at least a portion of the parameters on to the image data, which may then be displayed on a display device at block 180, such as in a single coordinate system, in order to provide a surgeon with data that may be utilized during the surgical procedure, for example. Alternatively, multiple sets of parameters may be obtained as part of a surgical procedure, such as instrument and/or in situ parameters, and these parameters may be recorded and subsequently played back after the procedure has been completed, such as in an academic setting, a quality assurance conference, and/or during a morbidity and mortality (M&M) conference, as just an example, although claimed subject matter is not so limited. Additionally, one or more of the aforementioned operations may be repeated, such as by accessing imaging data, determining instrument parameters, determining in situ parameters, registering one or more parameters, and/or displaying one or more parameters, which may result in a previously displayed image being updated, and the updating may occur continually during a surgical procedure, as just an example.

Referring now to FIG. 6, there is illustrated a block diagram of an embodiment of a PAIGS system 190. Illustrated in FIG. 6 is a patient 192 and a surgical instrument 193. As described previously, patient 192 may include a surgical object (not shown), and surgical instrument 193 may include one or more sensors (not shown), and may comprise one or more types of surgical instrument, such as described previously. The one or more sensors may be capable of providing patient in situ parameters and instrument parameters to computing system 198, for example. Computing system 198 may comprise one or more types of computing system, such as a computing system capable of receiving and/or processing one or more types of surgical data, for example, and claimed subject matter is not limited in this respect. However, continuing with this embodiment, computing system 198 may be capable of receiving surgical data 194 and image data 196, for example, and may be capable of providing a surgical plan 200, which may be configured to be displayed on a display 202, for example.

In operation, system 190 may operate substantially in the following manner: A patient, such as patient 192, may be utilized to produce one or more images, which may comprise images of a surgical object of the patient or of one or more other portions of the patient, for example. The image data 196 may be obtained by use of one or more imaging devices, for example, and may be provided to computing system 198. The image data 196 may be at least partially utilized to determine a suitable set of surgical data 194, which may be determined to be suitable based on one or more factors, including anatomy data obtained by the imaging, for example, and/or may be based on other factors including patient history, planned surgical procedure, and/or one or more other factors, but claimed subject matter is not limited in this respect. After suitable surgical data is obtained, the surgical data may be provided to computing system 198. In at least one embodiment, the surgical data provided may comprise a proposed surgical path, a recorded surgical procedure, and/or a simulation of a surgical object and/or other portions of a patient, for example, such as if the image data does not produce an acceptable image of the surgical object, for example. Surgical data 194 may be obtained from previously performed surgical procedures, for example, and/or may be developed from simulated surgical procedures, and may comprise a combination of one or more of these surgical procedures, for example. The surgical data 194 and/or image data 196 may then be utilized by computing system 198 to produce a surgical plan 200, which may comprise a surgical path and/or other image data relating to the planned surgical procedure, for example. Additionally, a surgical instrument 193 may provide particular parameters, including in situ and/or instrument parameters to computing system 198, and the computing system may modify and/or enhance the surgical plan based at least in part on the provided parameters, and/or may update the surgical plan during the procedure, such as to produce an image including in situ and/or instrument data in addition to a surgical plan, such as one or more images that may be produced in systems 100 and 120, for example. The surgeon 204, which may comprise a human and/or robotic surgeon, for example, may be capable of modifying and/or updating the image displayed on display 202, as by selecting different instrument and/or in situ parameters to display, for example, and/or may be capable of selecting different images to display. In at least one embodiment, display may comprise one or more of a liquid crystal display (LCD), a cathode ray tube (CRT) display, a 3D display, a holographic display and/or a virtual reality display, for example, and may be capable of displaying multiple images, such as illustrated in FIG. 4.

Alternatively, during a surgical procedure, computing system 198 may be configured to utilize at least a portion of in situ parameters to perform an analysis, such as by sampling of at least a portion of the biopsy sample. The analysis and/or sampling of the biopsy sample may be performed automatically based on the detection of particular parameters, for example, and/or may be initiated by surgeon 204, such as when a particular portion of the surgical object is encountered, for example. In this embodiment, the computing system 198 may sample a surgical object, such as by performing one or more actions on a portion of the surgical object, which may include removing at least a portion of the surgical object, and performing one or more tests on the portion, such as performing a biopsy on the portion, for example, and/or may comprise sampling an electrical signal and/or determining one or more chemical characteristics, for example. In one embodiment, the computing system 198 may perform a biopsy analysis on the obtained sample, and may be capable of providing the results of the biopsy to display device 202, such that display device 202 may display an image that includes the results of a biopsy analysis as part of one or more other images comprising instrument parameters, in situ parameters and/or image data of patient 192, for example. Additionally, as part of biopsy analysis, computing system 198 may be capable of producing a recommended surgical action, such as removal of a portion of a surgical object that may have a particular biopsy, for example. As another example, the computing system 198 may produce a recommendation for a surgical non-action. In yet another example, the computing system 198 can guide a surgical robot to perform a surgical action based in part on the biopsy analysis.

It is, of course, now appreciated, based at least in part on the foregoing disclosure that a combination of hardware with software and/or firmware may be produced capable of performing a variety of operations, including one or more of the foregoing imaging and/or surgical procedures as described previously. It will additionally be understood that, although particular embodiments have just been described, claimed subject matter is not limited in scope to a particular embodiment or implementation. For example, a system capable of implementing one or more of the abovementioned operations may comprise hardware, such as implemented to operate on a device or combination of devices as previously described, for example, whereas another embodiment may be in hardware and software. Likewise, an embodiment of a system capable of implementing one or more of the abovementioned operations may be implemented in hardware and firmware, for example. Additionally, all or a portion of one embodiment may be implemented to operate at least partially in one device, such as an ejection device, a computing device, a set top box, a cell phone, and/or a personal digital assistant (PDA), for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, a set top box, a cell phone and/or a personal digital assistant (PDA), for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive, although, again, claimed subject matter is not limited in scope to this example.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method, comprising:
accessing image data;
receiving one or more instrument parameters from one or more sensors coupled to an instrument;
receiving one or more in situ parameters for an object from one or more sensors coupled to the instrument;
providing one or more instrument parameters, in situ parameters, and/or at least a portion of the image data to a registration device; and
displaying an image of at least a portion of the instrument parameters, in situ parameters and/or image data provided to the registration device on a display device.

2. The method of claim 1, and further comprising:
registering at least a portion of said provided instrument parameters, image data and in situ parameters, wherein said registering comprises:
integrating at least a portion of the provided data, to produce a set of data having a single coordinate system.

3. The method of claim 1, wherein said surgical object comprises a patient or a portion thereof.

4. The method of claim 1, wherein said instrument parameters comprise orientation and/or position data.

5. The method of claim 4, wherein said instrument parameters comprise historical position and/or orientation data.

6. The method of claim 1, wherein said one or more in situ parameters comprises one or more of: physical, chemical and/or electrical parameters.

7. The method of claim 6, wherein said one or more in situ parameters comprises one or more of: pressure, stress, temperature, density, displacement, velocity, flow, acceleration, elasticity, hardness, frequency, oxygen concentration, glucose concentration, impedance, potential, current and/or parameters at least partially derived therefrom.

8. The method of claim 1, wherein said display device comprises at least one of a liquid crystal display (LCD), cathode ray tube (CRT) display, 3D display, holographic display and/or virtual reality display.

9. The method of claim 1, wherein said image data is stored on a data storage device.

10. The method of claim 5, and further comprising:
receiving two or more position and/or orientation data sets from the surgical instrument, wherein the two or more data sets are obtained from the surgical instrument at differing times; and
providing at least a portion of said two or more data sets to a display device, to display the historical position and/or orientation data of a surgical instrument on the display device.

11. A computer executable program, comprising:
at least one machine readable medium;
computer code stored on the at least one machine readable medium comprising instructions for accessing data, wherein at least a portion of said data comprises one or more in situ parameters for a surgical instrument and image data for a surgical object, and optionally one or more instrument parameters; and
registering at least a portion of said data to produce an image, wherein the image comprises a representation of said one or more in situ parameters for a surgical instrument and optionally one or more instrument parameters at least partially superimposed on said image data.

12. The computer executable program of claim 11, wherein said instrument parameters comprise orientation and/or position data.

13. The computer executable program of claim 12, wherein said instrument parameters comprise historical position and/or orientation data.

14. The computer executable program of claim 11, wherein said surgical object comprises a patient or a portion thereof.

15. The computer executable program of claim 11, wherein said image is displayed on a display device, wherein said display device comprises at least one of a liquid crystal display (LCD), a cathode ray tube (CRT) display, a 3D display, a holographic display and/or a virtual reality display.

16. The computer executable program of claim 13, and further comprising:
receiving two or more position and/or orientation data sets from the surgical instrument, wherein the two or more data sets are obtained from the surgical instrument at differing times; and
providing at least a portion of said two or more data sets to a display device, to display the historical position and/or orientation data of a surgical instrument on the display device.

17. A method, comprising:
accessing recorded surgical procedure data, wherein at least a portion of said recorded surgical procedure data comprises surgical instrument data, surgical object data, and/or in situ data, wherein at least a portion of said data is at least partially generated based at least in part on data received from a surgical instrument having one or more orientation, in situ and/or position sensors.

18. The method of claim 17, and further comprising displaying at least a portion of said recorded surgical procedure data on a display device.

19. The method of claim 17, wherein at least a portion of said displayed data comprises a playback of a surgical procedure and/or a real time display of a surgical procedure, wherein said displayed data is displayed on a display device comprising at least one of a liquid crystal display (LCD), a cathode ray tube (CRT) display, a 3D display, a holographic display and/or a virtual reality display.

20. The method of claim 17, wherein said surgical object comprises a patient or a portion thereof.

21. The method of claim 17, wherein said surgical instrument data comprises historical position and/or orientation data.

22. The method of claim 18, and further comprising:
altering the transparency and/or brightness and contrast of the displayed simulation during the playback.

23. The method of claim 17, wherein said surgical instrument data comprises one or more of: physical, chemical and/or electrical in situ parameters.

24. The method of claim 23, wherein said one or more physical, chemical and/or electrical in situ parameters comprises one or more of: pressure, stress, temperature, density, displacement, velocity, flow, acceleration, elasticity, hardness, frequency, oxygen concentration, glucose concentration, impedance, potential, current and/or parameters at least partially derived therefrom.

25. The method of claim 17, and further comprising:
forming a surgery plan for the surgical instrument based on at least in part on the previous surgical procedure.

26. The method of claim 25, and further comprising:
guiding a surgical instrument at least partly based on the surgery plan.

27. An apparatus, comprising:
a surgical instrument, the surgical instrument having one or more sensors, wherein at least a portion of the one or more sensors is capable of sensing orientation and position data, and at least a portion of the one or more sensors is capable of sensing surgical in situ parameters.

28. The apparatus of claim 27, wherein said surgical instrument comprises one or more of: an anatomical device, a probe, a drill, a guide, a catheter, a stimulator, a debrider, an aspirator, a curette, forceps, a bovie, a microscope, an endoscope, and/or one or more implants.

29. The apparatus of claim 27, wherein at least a portion of said sensors are located remotely from the surgical instrument.

30. The apparatus of claim 27, wherein at least a portion of said sensors are at least partially embedded in the surgical instrument.

31. The apparatus of claim 27, wherein said orientation and position data comprises one or more of: relative x, y, and/or z position of the instrument, and/or pitch, yaw and/or roll.

32. The apparatus of claim 31, wherein said orientation and position data comprises historical position and/or orientation data.

33. The apparatus of claim 27, wherein surgical in situ parameters comprises one or more of: physical, chemical and/or electrical parameters.

34. The apparatus of claim 33 wherein surgical in situ parameters comprises one or more of: pressure, stress, temperature, density, displacement, velocity, flow, acceleration, elasticity, hardness, frequency, oxygen concentration, glucose concentration, impedance, potential, current and/or parameters at least partially derived therefrom.

35. A method, comprising:
automatically performing image-guided biopsy analysis on a surgical object, wherein said image-guided biopsy analysis is performed based at least on data obtained from a surgical instrument capable of obtaining in situ data from the object; and
performing in situ surgical action based at least in part on said biopsy analysis.

36. The method of claim 35, wherein said in situ data is at least partially obtained by sampling.

37. The method of claim 35, wherein said in situ surgical action comprises one or more of: excising, ablation, cutting, aspirating, implanting, surgical non-action and/or analyzing.

38. The method of claim 35, wherein said in situ surgical action comprises altering a surgical plan.
